(19) United States
(12) Patent Application Publication
(10) Pub. No.: US 2002/0102957 A1
(43) Pub. Date: Aug. 1, 2002

(54) Radio signal receiving control device and the control method for the same

(76) Inventors: Han-Yang Tseng, Taipei Hsien (TW); Ru-Lin Chia, Taipei Hsien (TW)

Correspondence Address: STROOCK & STROOCK & LAVAN LLP, 180 Maiden Lane, New York, NY, 10038, US

(21) Appl. No.: 09/772,171

(22) Filed: Jan. 29, 2001

(51) Int. Cl. H04B 1/06

(52) U.S. Cl. 455/257; 375/344

(57) ABSTRACT

A radio signal receiving control device and the control method for the same. The disclosed radio signal receiving control method is to utilize the phenomenon that when IF frequency between the radio transmitter and the receiver shifts the bit duration received will change accordingly, to detect the bit duration variation of received data, thus adjusting the frequency of local oscillator signal. In the radio signal receiving control device, an AND gate connects to the output terminal of the radio signal receiving device and a counter connects to the AND gate. A feedback controller connects to the counter and a comparer, a digital/analog converter connects to the feedback controller. A varactor diode connects to the digital/analog converter and a local oscillator of the radio signal receiving device

### BACKGROUND OF THE INVENTION

1. Field of Invention

The present invention relates to a radio signal receiving control device and the method for the same and, more particularly, to a control device that can automatically correct the frequency of received radio signals.

2. Related Art

As modern electronic and communications technologies continuously grow, wireless communications systems also progress in a rapid speed. Using a portable electronic data receiving device as a real time information display is widely accepted by the public. For a communications system, such devices as the pager, beeper, mobile phone and other wireless transmission devices have become very important personal communication tools.

There are wireless signal receiving device in a common wireless communication system, whose primary function is to receive external radio signals. Taking a pager as an example, when a signal sender wants to send some message to the user of the pager, the sender sends the pager number and the message code to a base station, which then transmits radio signals to the receiver according to the pager number. When the receiver receives the radio signals, the pager will notify the user of the incoming message and display the message on a screen.

Please refer to FIG. 1, which is a block diagram of a conventional radio receiver. In such a conventional radio receiver 100, radio signals are received by antenna 102 and amplified by a low-noise amplifier (LNA) 104. Image interfering signals are filtered out from the amplified signals by a radio frequency band-pass filter (RFBPF) 106 and then pass to a mixer 108. The filtered signals and the local oscillating signal from a local oscillator 110 are processed by the mixer 108 to generate an intermediate frequency (IF).

As shown in FIG. 1, the IF output from the mixer 108 is filtered out the noise signals by an intermediate frequency band-pass filter (IFBPF) 112 and gets amplified and output by an IF amplifier 114. The amplified signals are demodulated by a demodulator 116 so as to obtain the base band analog signals (BBASs). The BBASs are then pass to a low-pass filter 118, which filters out noises other than the base band, and then a comparator 120. The comparator takes a reference voltage to convert filtered BBASs into digital signals, which are then output to a digital circuit for processing and reading out the contents of the received message.

To enhance the sensitivity of the radio receiver, the bandwidth of the commonly adopted IFBPF (also called the channel filter) is the minimal bandwidth needed for modulated signals to pass in order to improve the signal-to-noise ratio (S/N) of received signals and to obtain sufficient adjacent channel rejection.

When using such a conventional radio receiver 100, the intermediate signals are generated by mixing external carrier signals and the local oscillating signals output from a local oscillator 110 in a mixer 108. When the IF has a shift, however, the received signals will be attenuated due to the influence of the IFBPF with a narrow bandwidth, resulting in the decrease of sensitivity to the received signals and cause the increase of the data bit error rate. Therefore, the local oscillator 110 in the conventional radio receiver 100 has to operate under a stable condition. The local oscillator frequency output therefrom also has to accurately tuned so that the IF signals have the correct frequency.

Unlike normal analog signal receivers in, for example, the frequency modulation (FM) radio are often equipped with an automatic frequency control (AFC) circuit which can work well by just extracting the DC component of the received signal, the signals 0 and 1 in the received digital modulated signal are not symmetric; that is, the number of data 0 and 1 are not necessarily the same. And in order to lower the bandwidth needed for data transmission, bit data usually transmitted in a non-return to zero (NRZ) method. Therefore, there is no way to perform feedback control over the local oscillator by just extracting the DC component of the received signal.

As to the above-mentioned problems of decreasing sensitivity to received signals and increasing data bit error rate, there are two commonly adopted solutions: One is to use a local oscillator with high precision and the other is to use an IF filter with a wider bandwidth. Nonetheless, using a local oscillator with high precision in a radio receiver requires a higher cost and will result in complication in the receiver manufacturing process.

Furthermore, since all parts in the radio receiver have respective temperature variation characters, to prevent signal frequency shifts due to temperature variations there should be provided with a temperature compensation circuit or a constant temperature oven to keep the temperature of the local oscillator invariant. However, using the constant temperature oven consumes much more power and is not suitable for the widely used portable communications devices. Moreover, parts in the radio receiver have the aging problem due to uses, which will also result in the local oscillator frequency shifts. Thus, they need to be calibrated from time to time to maintain good functioning. This will increase the cost and cause inconvenience for users. Besides, such methods cannot completely solve the frequency shifts in the radio signal emission end.

The frequency shift phenomena between the radio transmitter and receiver due to adjustments, temperature variations and aging parts can be improved by increasing the bandwidth of the IFBPF, yet some noise signals will pass through the filter at the same time as the bandwidth of the IFBPF is increased, thus decreasing the sensitivity of the radio receiver. This method of accepting frequency shifts by increasing the bandwidth is less effective as the frequencies of the radio spectrum used get higher, making the frequency shifts more serious. In addition, since the bandwidth of the IF cannot be increased without limit and it has to satisfy the requirement of adjacent channel rejection for radio receivers, this method will fail when the frequencies of the radio spectrum used get higher.

### SUMMARY OF THE INVENTION

In view of the foregoing and the fact that when the IF frequency between the radio transmitter and the receiver shifts the bit duration of the data received will change accordingly, it is thus an object of the present invention to provide a radio signal receiving control device, which detects the variation of the bit duration of the data received by using an over-sampling circuit and adjusts the frequency of local oscillator through a feedback control method after operation processes. By correcting the local oscillator frequency, the IF frequency between the radio transmitter and receiver is kept at the receiving state with the best sensitivity.

It is another object of the present invention to provide a radio signal receiving control method, which utilizes the feature that when the IF frequency between the radio transmitter and the receiver shifts the bit duration of the data received will change accordingly, to detect the variation of the bit duration of the data received by over-sampling. After further operations, the frequency of the local oscillator is adjusted by feedback control to obtain the correct intermediate frequency (IF) of the receiver and the lowest data bit error rate be obtained.

According to the above and other objects, the invention provides a radio signal receiving control device to control radio signal receiving devices with antennas, mixers, local oscillators, demodulators and comparators. The radio signal receiving control device comprises an AND gate, a counter, a feedback controller, a digital/analog (D/A) converter and a varactor diode; wherein the AND gate connects to the comparator of the radio signal receiving device, the counter connects to the AND gate, the feedback controller connects to both the counter and the comparator, the D/A converter connects to the feedback controller, and the varactor diode connects to both the D/A converter and the local oscillator of the radio signal receiving device.

Furthermore, according to the above and other objects, the invention also provides a radio signal receiving system, which comprises: an antenna and a local oscillator for receiving signals; a mixer for generating IF signals; a demodulator connecting to the mixer and low-pass filter for generating a base band analog signal (BBAS); a voltage comparator converts BBAS to digital signal; an AND gate connecting to the comparator and over-sampling clock generator in order to generate a sampling pulse to counter; a feedback controller connecting to the counter and a D/A converter to process the counting value output from the counter to generate a correction signal to the D/A converter; a varactor diode connecting to both the D/A converter and the local oscillator for the D/A converter to adjust its capacitance, thus correcting the frequency of the local oscillator.

According to the above and other objects, the invention further provides a radio signal receiving control method, wherein the radio signals received are converted to the corresponding digital signals for automatically calibrating the receiving frequency. First, an over-sampling clock is utilized to perform specific ratio sampling over the converted digital signals and to generate a sampling pulse. The sampling pulse is then counted to generate a counting value with bit duration data. The relation between the counting value and the over-sampling ratio is used to calculate and adjust the output voltage, whereby the local oscillating frequency is adjusted.

Pursuant to the above and other objects, the present invention also provides a control method for receiving signals, wherein the signals received are converted to the corresponding digital signals for automatically calibrating the receiving frequency. First, an over-sampling clock is utilized to perform specific ratio sampling over the converted digital signals and to generate a sampling pulse. The sampling pulse is then counted to generate a counting value with bit duration data. The relation between the counting value and the over-sampling ratio is used to calculate and adjust the output voltage, whereby the local oscillating frequency is adjusted and the adjusted local oscillating signals and the received signals are mixed in frequency.

### BRIEF DESCRIPTION OF THE DRAWINGS

The present invention will become more fully understood from the detailed description given hereinbelow illustration only, and thus are not limitative of the present invention, and wherein:

FIG. 1 is a block diagram of a conventional radio receiver;

FIG. 2 is a schematic block diagram of a radio receiver system according to a preferred embodiment of the invention;

FIG. 3 shows a schematic spectrum when the local oscillator frequency and the central frequency of the carrier can form a beat with the correct IF;

FIG. 4 shows a comparison diagram of an analogue signal of the base band and the corresponding digital signals when the local oscillator frequency and the central frequency of the carrier can form a beat with the correct IF;

FIG. 5 shows a schematic spectrum when the local oscillator frequency and the central frequency of the carrier form a beat with shifted IF;

FIG. 6 shows a comparison diagram of an analogue signal of the base band and the corresponding digital signals when the local oscillator frequency and the central frequency of the carrier form a beat with shifted IF;

FIG. 7 shows a schematic flow chart of the radio signal receiving control method according to a preferred embodiment of the invention;

FIG. 8 is a time-ordered diagram of various signals during the process of fine-tuning when the central frequency of the carrier increases or the local oscillator frequency decreases according to a radio signal receiving control method in a preferred embodiment of the invention;

FIG. 9 is a time-ordered diagram of various signals during the process of fine-tuning when the central frequency of the carrier decreases or the local oscillator frequency increases according to a radio signal receiving control method in a preferred embodiment of the invention; and

FIG. 10 is a time-ordered diagram of various signals during the process of fine-tuning when the deviation between the central frequency of the carrier and the local oscillator frequency is too large according to a radio signal receiving control method in a preferred embodiment of the invention.

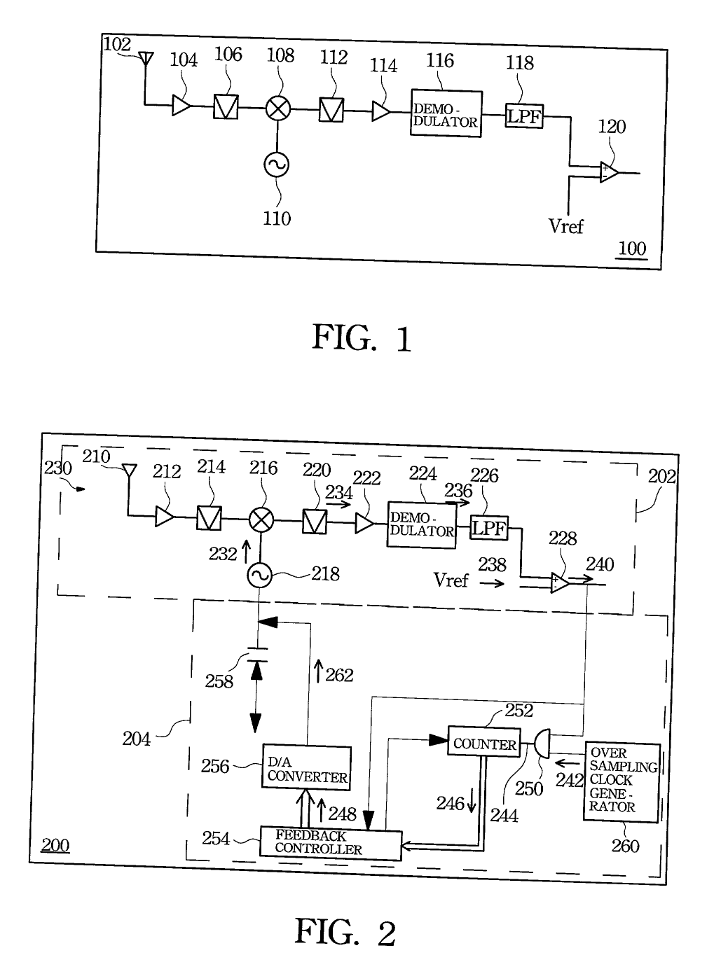

### DETAILED DESCRIPTION OF THE INVENTION

Please refer to FIG. 2, which is a schematic block diagram of a radio receiver system according to a preferred embodiment of the invention. The radio signal receiving system 200 includes a radio signal receiving device 202 and a radio signal receiving control device 204. The radio receiver 202 is analogous to the conventional radio receiver and comprises an antenna 210, a low noise amplifier 212, a radio frequency band-pass filter (RFBPF) 214, a mixer 216, a local oscillator 218, an intermediate frequency band-pass filter (IFBPF) 220, an intermediate frequency (IF) amplifier 222, a demodulator 224, a low-pass filter 226 and a comparator 228.

As shown in the drawing, in the radio signal receiving device 202 the antenna 210 receives radio signals 230 transmitted by the corresponding radio transmitting system such as the radio signals from a base station. The low noise amplifier 212 connects to the antenna 210 and the RFBPF 214 to amplify the radio signals 230 and to output the amplified radio signals 230 to the RFBPF 214 for filtering out image interference signals. The mixer 216 connects to the RFBPF 214 and the local oscillator 218 to process the filtered radio signal 230 and the local oscillator signal 232 from the local oscillator 218 and to generate IF signal 234.

The IFBPF 220 connects between the mixer 216 and the IF amplifier 222. After the IFBPF 220 filters out all noise signals other than the receiving channel from the IF signal 234, the signal 234 then amplified and output by the IF amplifier 222. The demodulator 224 connects between the IF amplifier 222 and the low-pass filter 226. The amplified IF signal 234 then demodulated to the base band analog signal (BBAS) 236 by the demodulator 224. The BBAS 236 is then sent to the low-pass filter 226 to filter out noise signals other than the required base band. The comparator 228 connects to the low-pass filter 226. It is a voltage comparator, the input terminal takes the reference voltage 238 to convert the BBAS 236 into output digital signal 240 for other digital circuits (not shown) to process the contents of the received message.

The radio signal receiving control device 204 in FIG. 2 controls the radio signal receiving device 202. It comprises an AND gate 250, a counter 252, a feedback controller 254, a digital/analog (D/A) converter 256, a varactor diode 258 and an over-sampling clock generator 260. The AND gate 250 connects to the counter 252 and the comparator 228 of the radio signal receiving device 202. The input terminal thereof sampling the digital signals 240 from the comparator 228 with over-sampling clock 242 which with a frequency higher than the data symble rate and generated from an over-sampling clock generator 260. The AND gate 250 sampling the input signals to generate a sampling pulse 244, which is then output to the counter 252. The counter 252 counts the sampling pulse 244 from the AND gate 250 to generate a counting value 246 to be output. The counting value is the data bit duration of the received signals.

The feedback controller 254 connects to the counter 252, the D/A converter 256 and the comparator 228 of the radio signal receiving device 202 for reading in the counting value 246 output from the counter 252 and performing calculations according to the counting value 246 so as to generate a correction signal 248. The D/A converter 256 converts the correction signal 248 from the feedback controller 254 to generate the corresponding correction voltage 262. The varactor diode 258 connects to the D/A converter 256 and the local oscillator 218 of the radio signal receiving device 202. The varactor diode 258 is controlled by the correction voltage output from the D/A converter 256, whereby the frequency of the local oscillator signal 232 output from the local oscillator 218 of the radio signal receiving device 202 can be controlled.

The main function of the local oscillator 218 of the receiving device 202 in the radio signal receiving system 200 is to generate local oscillator signals 232. The radio transmitting system corresponding to the radio signal receiving system 200 uses a carrier with a specific carrier central frequency to transmit messages. When the frequency of the local oscillator signal 232 and the carrier central frequency can form a correct IF by beating in the mixer 216, the noise signals can be lowered to improve the signal-to-noise (S/N) ratio through the feature that it has the IFBPF with the minimal bandwidth needed for the modulated signals to pass through.

The present invention can nevertheless be applied to cable signal receiving control, where the radio signal receiving device can be substituted by a cable signal receiving device and the antenna for receiving radio signals can be substituted by the cable for receiving cable signals.

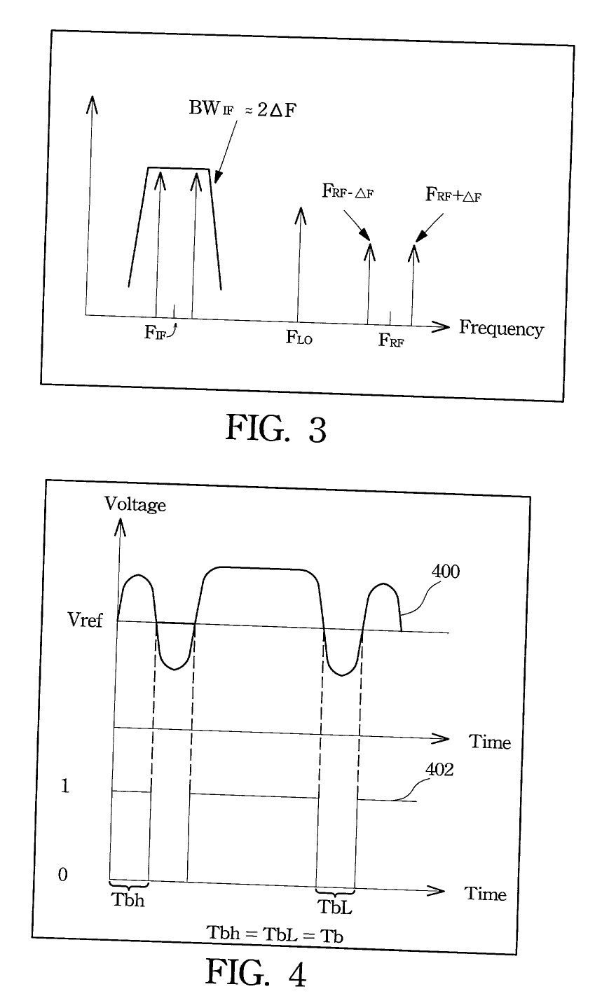

Please refer to FIG. 3, which shows a schematic spectrum when the local oscillating frequency and the central frequency of the carrier can form a beat with the correct IF. In the drawing, the horizontal axis represents the frequency. F_{RF} is the carrier central frequency, F_{RF-ΔF} and F_{RF+ΔF} are signal frequencies, F_{LO} is the local oscillator frequency, F_{IF} is the IF signal frequency and F_{IF}=F_{RF}−F_{LO}, and BW_{IF} is the bandwidth of the IFBPF (BW_{IF}≈2ΔF).

FIG. 4 shows a comparison diagram of an analogue signal of the base band and the corresponding digital signals when the local oscillator frequency and the central frequency of the carrier can form a beat with the correct IF. The horizontal axis represents the time and the vertical axis represents the voltage. As described hereinbefore, the BBAS 400 in the drawing is obtained by letting IF signal pass through the demodulator and the LPF. The digital signal 402 corresponding to the BBAS 400 is generated after the comparison of the BBAS and the reference voltage V_{ref} by the voltage comparator. When the local oscillator frequency and the carrier central frequency can form a beat with the correct IF, the BBAS 400 are symmetric to the reference voltage V_{ref}. Therefore, the output digital signal 402 output from the voltage comparator has the correct bit duration T_{b}.

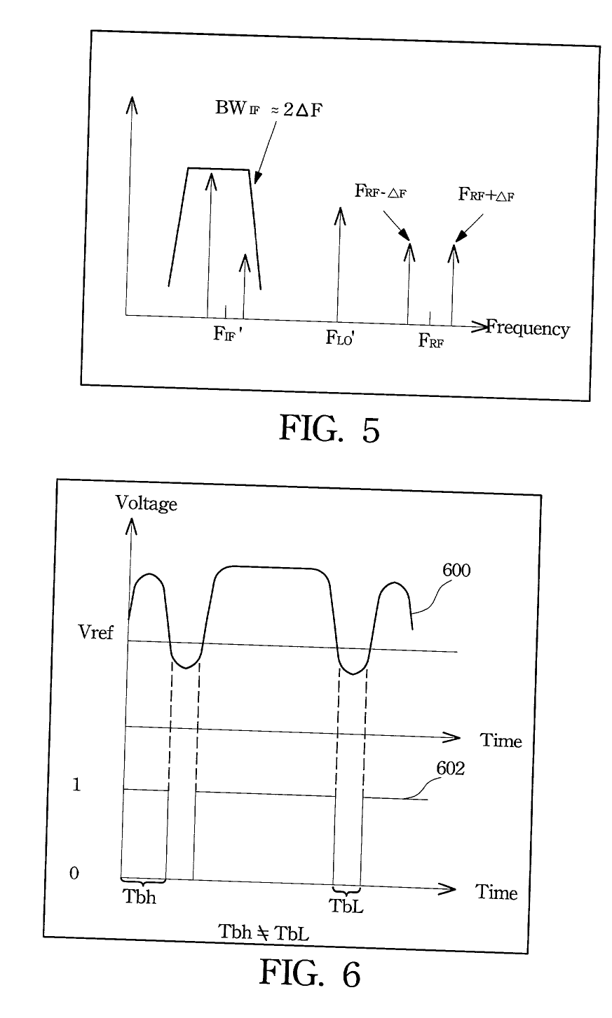

When the IF obtained from the beat of the carrier frequency of the radio transmitting system and the local oscillator frequency of the radio signal receiving system shifts, the IF is attenuated by the IFBPF, resulting in the decrease in sensitivity to the signal reception. Please refer to FIG. 5, which shows a schematic spectrum when the local oscillator frequency and the central frequency of the carrier form a beat with shifted IF. FIG. 5 is similar to FIG. 3, where the horizontal axis represents the frequency and the same signal is referred by the same number. F_{LO′} is the shifted local oscillating frequency, F_{IF′} is the shifted IF signal frequency and F_{IF′}=F_{RF}−F_{LO′}, and BW_{IF} is the bandwidth of the IFBPF (BW_{IF}≈2ΔF).

FIG. 6 shows a comparison diagram of the base band analog signal and the corresponding digital signal of FIG. 5. As shown in the drawing, when the IF obtained from the beat of the carrier frequency of the radio transmitting system and the local oscillator frequency of the radio signal receiving system shifts, the BBAS 600 are not symmetric to the reference voltage V_{ref} due to the DC component shift resulted from the IF shift, which further make the corresponding digital signal 602 generate an incorrect bit duration.

Using the radio signal receiving control device of the invention can improve the malicious influence due to frequency shifts. With further reference to FIG. 2, the over-sampling clock generator 260 is used to generate the over-sampling clock 242. The over-sampling clock 242 with a frequency higher than the data symble rate and the digital signal 240 are processed by the AND gate 250 and the counter 252. After sampling and counting, a counting value 246 with bit duration data is obtained. The counting value 246 is sent to the feedback controller 254 to perform calculations so as to adjust the frequency of the local oscillator 218 in the radio signal receiving device 202.

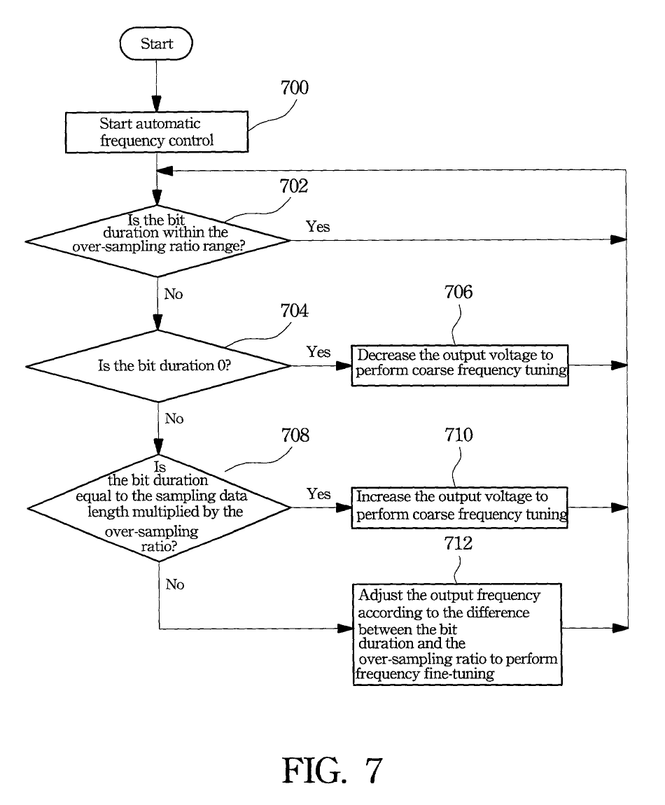

Please refer to FIG. 7, which shows a schematic flow chart of the radio signal receiving control method according to a preferred embodiment of the invention. With reference to FIGS. 7 and 2 at the same time, when performing controls of receiving radio signals, an automatic frequency control (AFC) is first started to receive external signals (e.g. radio signals) and to convert them into digital signal for output, as shown by step 700 in FIG. 7. Aside from allowing a digital circuit to process the contents of the received message, the digital signal is also used to perform AFC. For example, when using the radio signal receiving system 200 the radio signal receiving device 202 is started to amplify and filter the received radio signals, which are then mixed with the local oscillator signal to generate IF signal. The IF signal is then filtered, amplified, and demodulated to BBAS. After filtering out noise signals, the BBAS is compared with a reference voltage to generate digital signal for output and reading out the contents of the received message. The output is also provided for the radio signal receiving control device 204 to perform feedback control.

Furthermore, an over-sampling clock is used to perform logic determinations with an over-sampling ratio of N to generate a sampling pulse. The sampling pulse is then used to count to obtain a counting value BD. The over-sampling ratio N is the ratio of the over-sampling clock frequency and data symbol rate. When the sampling is a one-bit sampling, the bit duration D is equal to the counting value (D=BD). If it is an average sampling, the bit duration is the counting value divided by the number H, which H is the number of logic 1 in the sampled data with length S; that is, D=BD/H. The sample data length S is used to determine the default time out in the scanning mode. Usually, the sample data length S is greater than the maximal number of the continuous logic 1s in the system to prevent error actions from happening. When performing step 702 in FIG. 7, the obtained bit duration and the allowed deviation range of the over-sampling ratio are subject to determination. When the obtained bit duration D is within the allowed deviation range of the over-sampling ratio N, i.e., N−M≦D≦N+M where M is the allowed deviation, then the system does not perform frequency corrections on the local oscillator signals and step 702 is repeated. This is the signal tracking mode. Under such a tracking mode, the feedback controller in the control device will not refresh the output voltage V_{DAC} of the D/A converter. The varactor diode maintains the existing capacitance because the control voltage is not changed. Therefore, the system does not perform frequency corrections on the local oscillator of the receiving device.

If the bit duration D does not fall in the allowed deviation range M of the over-sampling ratio N, step 704 in FIG. 7 is proceeded to determine whether the obtained bit duration D is 0, that is, whether the received data do not have high-low change and stay at LOW. If the obtained bit duration D is0, then the received data are all LOW. Step 706 in FIG. 7 decrease the output voltage of the D/A converter by a predetermined decrement; that is, V_{DAC}=V_{DAC-V}_{STEP}. The local oscillator frequency is subject to fast calibration by coarse tuning. Step 702 is then repeated.

If the obtained bit duration D in step 704 is not always 0, step 708 in FIG. 7 is proceeded to determine whether the obtained counting value BD is equal to the sample data length S multiplied by the over-sampling ratio N, that is, whether the obtained data do not have any high-low change and stay at HIGH. If the obtained data do not have any high-low change and stay at HIGH (BD=S×N), then the process proceeds to step 710 in FIG. 7 to increase the output voltage of the D/A converter by a predetermined increment; that is, V_{DAC}=V_{DAC}+V_{STEP}. The local oscillator frequency is subject to fast calibration by coarse tuning. Step 702 is then repeated.

If the bit duration D does not fall into the allowed deviation range of the over-sampling ratio and the received data have high-low changes, then the process proceeds to step 712 in FIG. 7. The output voltage of the D/A converter is adjusted according to the difference between the bit duration D and the over-sampling ratio N and the ratio of the frequency variation to the voltage variation, in order to perform fine-tuning on the local oscillator frequency so that the bit duration D falls back into the allowed deviation range of the over-sampling ratio. Step 702 is then repeated. This is the fine tune mode.

When the carrier central frequency of the radio transmitting system increases or the local oscillator frequency of the radio signal receiving system decreases, the IF signal output from the mixer will increase, thus increasing the DC component in the BBAS generated by the demodulator. The bit duration of the logic 1 in the digital signal output from the voltage comparator extends longer. This extended bit duration will result in increases in the counting value of the counter. Under the signal fine tune mode, the output voltage of the D/A converter is corrected according to deviation between the bit duration D and the over-sampling ratio N after processing the counting value by the feedback controller, whereby the capacitance of the varactor diode can be changed. Decreasing the capacitance of the varactor diode can increase the frequency of the local oscillator. The fine tune process is repeated until the bit duration falls within the allowed range, making the receiving frequency of the receiving system tracking with that of the transmitting system.

On the other hand, if the carrier central frequency of the radio transmitting system decreases or the local oscillator frequency of the radio signal receiving system increases, the above method can be also used to perform corrections, increasing the capacitance of the varactor diode thus decreasing the local oscillator frequency. The fine tune process is repeated until the bit duration falls within the allowed range, making the receiving frequency of the receiving system tracking with that of the transmitting system.

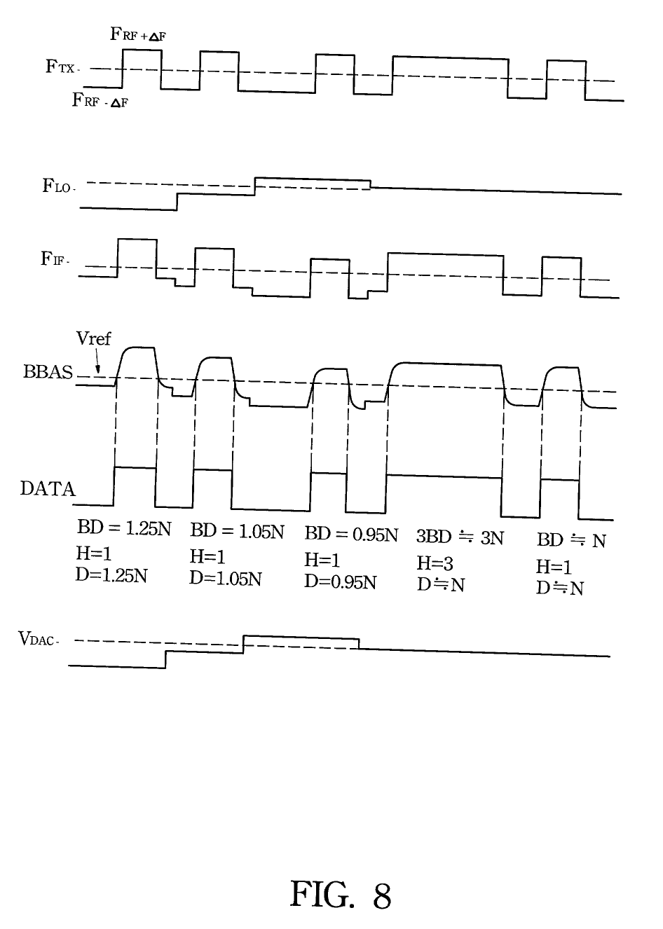

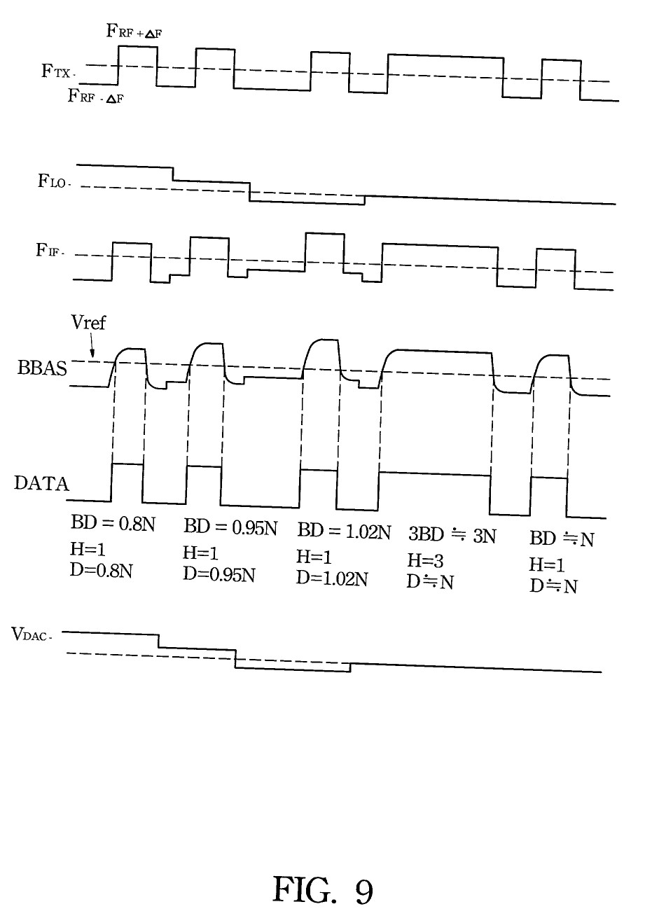

Please refer to FIG. 8, which is a time-ordered diagram of various signals during the process of fine-tuning when the central frequency of the carrier increases or the local oscillator frequency decreases. It includes the radio signal F_{TX} (including F_{RF-ΔF} and F_{RF+ΔF}), the local oscillating signal F_{LO}, the IF signal F_{IF}, the BBAS, the digital signal, and the output voltage signal V_{DAC}. FIG. 9 is analogous to FIG. 8. It shows a time-ordered diagram of various signals during the process of fine-tuning when the central frequency of the carrier decreases or the local oscillator frequency increases.

When the shift of the receiving frequency of the radio signal receiving system and the carrier central frequency of the transmitting system is too big, the digital signal output from the voltage comparator will not vary with the modulation signal of the transmitting system. With the bit duration output through the counter, the feedback controller can enter the scanning mode after a predetermined pause time and perform adjustment to the output voltage of the D/A converter by a predetermined voltage increment or decrement to increase or decrease the output voltage. This can change the capacitance of the varactor diode, coarse tuning the output frequency of the local oscillator. This summarizes steps 704 through 710 in FIG. 7. When the digital signals output from the receiving system vary with the modulation signals of the transmitting system, the feedback controller will resume the fine tune mode so that the whole system has the best consistency in transceiving frequency.

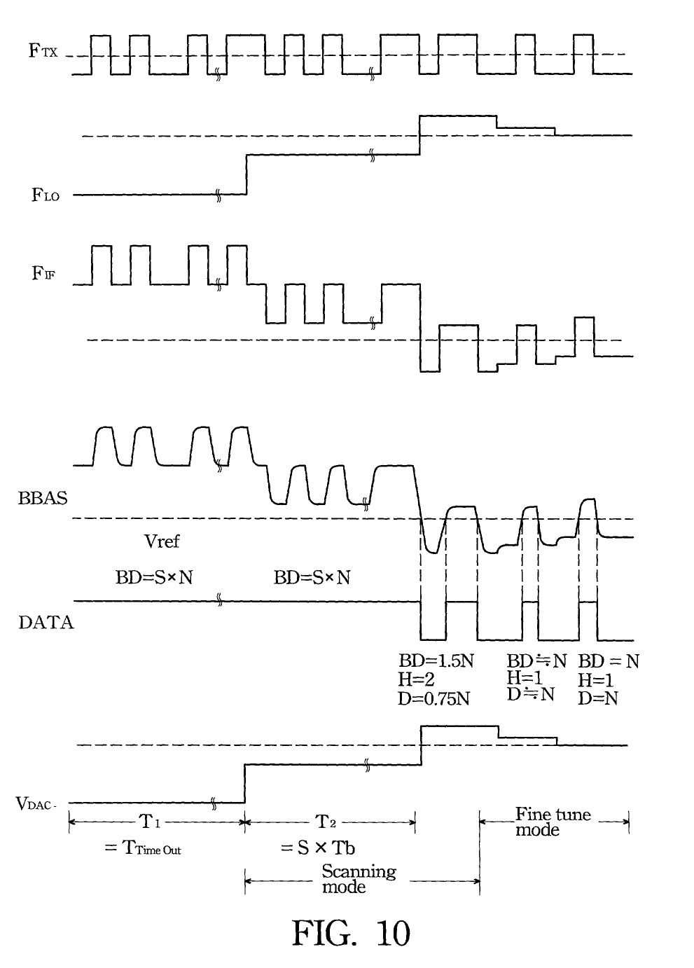

Please refer to FIG. 10, which is a time-ordered diagram of various signals during the process of AFC function, when the deviation between the central frequency of the carrier and the local oscillator frequency is too large. FIG. 10 is analogous to FIGS. 8 and 9. It includes the radio signal F_{TX} (including F_{RF-ΔF} and F_{RF+ΔF}), the local oscillating signal F_{LO}, the IF signal F_{IF}, the BBAS, the digital signal, and the output voltage signal V_{DAC}. The middle section of the whole time series is in the scanning mode and the later section is the fine tune mode.

From the above-mentioned preferred embodiments, one can know that the present invention can be applied to cable or wireless receiving devices that transmit digital or analog signals in a way of digital frequency modulated signal. The invention utilizes the feature that when the carrier frequency between the transmitting end and the receiving end shifts the bit duration of received data will vary, to perform automatic calibration on the receiving frequency. Therefore, the invention has the following advantages:

1. The invention uses an over-sampling circuit to detect the variation of the bit duration and feedback to correct the local oscillator frequency at the receiving end after calculations so that the receiving end is locked on the carrier frequency consistent with the transmitting end to get the correct receiving IF. Therefore, an IFBPF with the minimal bandwidth can be adopted to lower the noises, to improve the receiving sensitivity and the performance of the receiving system.

2. The invention uses a closed loop control method that can lower the requirement on the precision of the local oscillator. Therefore, a local oscillator with a lower precision can be used. For example, crystal with a lower precision and without temperature compensation can be the frequency control element of the local oscillator to lower the component cost and the costs in manufacturing and adjusting. Moreover, this can solve the problem caused by the carrier frequency shift at the transmitting end.

3. The invention can establish a test mode in software, which can perform automatic calibration in mass production to save the manual adjustment cost needed in conventional production methods.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A radio signal receiving control device for controlling a radio signal receiving device which receives a radio signal and comprises an antenna, a mixer, a local oscillator, a demodulator and a comparator with the mixer connects to the antenna and the local oscillator, the demodulator connects to the mixer and the comparator, the radio signal receiving control device connects to the comparator and the local oscillator, the radio signal receiving control device comprising:
an AND gate connects to the comparator and the over-sampling clock generator for sampling the digital signal output from the comparator with an over-sampling clock output from the over-sampling clock generator and outputting a sampling pulse;
a counter connects to the output terminal of the AND gate and counting the sampling pulse to output a counting value;
a feedback controller connects to the counter and the comparator for processing the counting value from the counter and outputting a correction signal according to the counting value;
a digital/analog (D/A) converter connects to the feedback controller for converting the correction signal from the feedback controller to a correction voltage output; and
a varactor diode connects to the D/A converter and the local oscillator, which controlled by the correction voltage from the D/A converter to change the capacitance of the varactor diode and to adjust the frequency of the local oscillator.

2. A radio signal receiving system comprising:
an antenna for receiving a radio signal;
a mixes connects to the antenna;
a local oscillator connects to the mixer for generating a local oscillating signal, the radio signal and the local oscillating signal being mixed and processed by the mixer to generate an intermediate frequency (IF) signal;
a demodulator connects to the mixer for demodulate the IF signal and produce a base band analog signal (BBAS);
a comparator connects to the demodulator comparing the BBAS output from the demodulator with a reference voltage to generate a digital signal;
an AND gate connects to the over-sampling clock and the digital signal output from the comparator to generate a sampling pulse;
a counter connects to the AND gate output and counting the sampling pulse to generate a counting value;
a feedback controller connects to both the counter output and the comparator output for processing the counting value output from the counter and generating a correction signal thereby;
a D/A converter connects to the feedback controller for converting the correction signal to a correction voltage output; and
a varactor diode connecting to the D/A converter and the local oscillator, which controlled by the correction voltage output from the D/A converter. By changing the capacitance of the varactor diode to adjust the frequency of the local oscillator.

3. The system of claim 2 further comprising an amplifier connects between the antenna and the mixer.

4. The system of claim 2 further comprising a radio frequency band-pass filter (RFBPF) connects between the antenna and the mixer.

5. The system of claim 2 further comprising an intermediate frequency band-pass filter (IFBPF) connects between the mixer and the demodulator.

6. The system of claim 2 further comprising an IF amplifier connects between the mixer and the demodulator.

7. The system of claim 2 further comprising a low-pass filter connects between the demodulator and the comparator.

8. A radio signal receiving system that can automatically correct a receiving frequency, which comprises:
an antenna for receiving a radio signal;
a low noise amplifier connects to the antenna for receiving and amplifying the radio signal;
a radio frequency band-pass filter (RFBPF) connects to the low noise amplifier for filtering the radio signal amplified by the low noise amplifier;
a mixer connects to the RFBPF;
a local oscillator connects to the mixer for generating a local oscillating signal, the radio signal and the local oscillating signal being mixed and processed by the mixer to generate an intermediate frequency (IF) signal;
an intermediate frequency band-pass filter (IFBPF) connects to the mixer for filtering the IF signal;
an IF amplifier connects to the IFBPF for amplifying the IF signal filtered by the IFBPF;
demodulator connects to the IF amplifier for demodulating the IF signal amplified by the IF amplifier and generating a base band analog signal (BBAS);
a low-pass filter connects to the demodulator for filtering the BBAS output from the demodulator;
a comparator connects to the demodulator for comparing the BBAS output from the demodulator with a reference voltage to generate a digital signal;
an AND gate connects to the over-sampling clock and the digital signal output from the comparator to generate a sampling pulse;
a counter connects to the AND gate output and counting the sampling pulse to generate a counting value;
a feedback controller connects to both the counter output and the comparator output for processing the counting value output from the counter and generating a correction signal thereby;
a D/A converter connects to the feedback controller for converting the correction signal to a correction voltage output; and
a varactor diode connecting to the D/A converter and the local oscillator, which controlled by the correction voltage output from the D/A converter. By changing the capacitance of the varactor diode thus adjust the frequency of the local oscillator.

9. A signal receiving control device for controlling a signal receiving device that receives a signal and comprises a signal receiver, a mixer, a local oscillator, a demodulator and a comparator with the mixer connects to the signal receiver and the local oscillator, the demodulator connects to the mixer and the comparator, the signal receiving control device connects to the comparator and the local oscillator, and the signal receiving control device comprising:
an AND gate connects to the comparator and over-sampling clock generator by over-sampling the digital signal output from the comparator to generate a sampling pulse;
a counter connects to the output terminal of the AND gate for counting the sampling pulse to generate a counting value;
a feedback controller connects to both the counter output and the comparator output for processing the counting value output from the counter and generating a correction signal thereby;
a D/A converter connects to the feedback controller for converting the correction signal from the feedback controller to generate a correction voltage output from the D/A converter; and
a varactor diode connects to the D/A converter and the local oscillator, which controlled by the correction voltage output from the D/A converter. By changing the capacitance of the varactor diode thus adjust the frequency of the local oscillator.

10. A radio signal receiving control method for automatically correcting a receiving frequency when receiving a radio signal and converting the radio signal into a corresponding digital signal, the method comprising the steps of:
sampling the digital signal using an over-sampling clock with an over-sampling ratio to generate a sampling pulse;
counting the sampling pulse to generate a counting value that has at least one bit duration datum;
determining the relation between the counting value and the over-sampling ratio, computing and adjusting an output voltage; and
adjusting local oscillator frequency according to the output voltage.

11. The method of claim 10, wherein the step of determining the relation between the counting value and the over-sampling ratio, computing and adjusting an output voltage further includes the step of decreasing the output voltage according to a predetermined decrement when the bit duration datum is 0.

12. The method of claim 10, wherein the step of determining the relation between the counting value and the over-sampling ratio, computing and adjusting an output voltage further includes the step of increasing the output voltage according to a predetermined increment when the counting value is equal to a sampling data length multiplied by the over-sampling ratio.

13. The method of claim 10, wherein the step of determining the relation between the counting value and the over-sampling ratio, computing and adjusting an output voltage further includes the step of adjusting the output voltage according to the difference between the bit duration datum and the sum of the over-sampling ratio and an allowed deviation when the counting value is not equal to the sampling data length multiplied by the over-sampling ratio and the bit duration datum is greater than the sum of the over-sampling ratio and the allowed deviation.

14. The method of claim 10, wherein the step of determining the relation between the counting value and the over-sampling ratio, computing and adjusting an output voltage further includes the step of adjusting the output voltage according to the difference between the bit duration datum and the balance of the over-sampling ratio and an allowed deviation when the bit duration datum is not equal to 0 and is smaller than the balance between the over-sampling ratio and the allowed deviation.

15. A radio signal receiving control method for automatically correcting a receiving frequency when receiving a radio signal and converting the radio signal into a corresponding digital signal, which method comprises the steps of:
sampling the digital signal using an over-sampling clock with an over-sampling ratio to generate a sampling pulse;
counting the sampling pulse to generate a counting value that has at least one bit duration datum;
determining the relation between the counting value and the over-sampling ratio, computing and adjusting an output voltage; and
adjusting a local oscillator frequency according to the output voltage so that a local oscillator signal with the local oscillator frequency mixes with the receiving signal.

16. The method of claim 15, wherein the step of determining the relation between the counting value and the over-sampling ratio, computing and adjusting an output voltage further includes the step of decreasing the output voltage according to a predetermined decrement when the bit duration datum is 0.

17. The method of claim 15, wherein the step of determining the relation between the counting value and the over-sampling ratio, computing and adjusting an output voltage further includes the step of increasing the output voltage according to a predetermined increment when the counting value is equal to a sampling data length multiplied by the over-sampling ratio.

18. The method of claim 15, wherein the step of determining the relation between the counting value and the over-sampling ratio, computing and adjusting an output voltage further includes the step of adjusting the output voltage according to the difference between the bit duration datum and the sum of the over-sampling ratio and an allowed deviation when the counting value is not equal to the sampling data length multiplied by the over-sampling ratio and the bit duration datum is greater than the sum of the over-sampling ratio and the allowed deviation.

19. The method of claim 15, wherein the step of determining the relation between the counting value and the over-sampling ratio, computing and adjusting an output voltage further includes the step of adjusting the output voltage according to the difference between the bit duration datum and the balance of the over-sampling ratio and the allowed deviation when the bit duration datum is not equal to 0 and is smaller than the balance between the over-sampling ratio and the allowed deviation.
